(19) United States
(12) Patent Application Publication
(10) Pub. No.: US 2015/0107749 A1
(43) Pub. Date: Apr. 23, 2015

(54) Process and Device for Gluing Dried Fibers Designated for the Production of Fiberboards

(71) Applicant: UNILIN, BVBA, Wielsbeke (BE)

(72) Inventors: Guenter HEYEN, Mount Gilead, NC (US); Ric AIKMAN, Albemarle, NC (US)

(73) Assignee: UNILIN, BVBA, Wielsbeke (BE)

(21) Appl. No.: 14/057,399

(22) Filed: Oct. 18, 2013

(51) Int. Cl. D21J 3/00; B05D 7/24; B05C 3/00

(52) U.S. Cl. CPC D21J 3/00; B05C 3/00; B05D 7/24
USPC 156/62.4; 156/578

(57) ABSTRACT

The present invention provides in a process for obtaining glued dried fibers suitable for the production of fiberboards, characterized by the following steps: carrying dried fibers in an air stream for the removal of high density contaminants from the dried fibers by means of gravity, and gluing said dried fibers. The invention thereto also provides a modified air density separator comprising one or more injection means for a gluing composition. The invention also relates to a fiber board manufacturing plant comprising an air density separator according to an embodiment of the invention.

### FIELD

This invention relates to improved processes and devices for gluing dried fibers designated for the production of fiberboards. The invention also relates to a plant for producing wood fiberboard panels by a dry process, which uses the gluing machine. The fibers preferably consist of lignocellulose-containing and/or cellulose-containing materials. The fiberboards are light, medium-density or high density fiber-boards.

### BACKGROUND

As is well known to the expert of the art, fiberboards are produced by pressing and heating a mat of glued fibers. The fibers originate e.g. from fresh debarked wood, which is ground and/or chemically decomposed to fiber level. The fibers are then dried and provided with glue before they are assembled to a mat of glued fibers to be pressed. From the viewpoint of providing the glue on the fibers known plants for the production of fiberboards can be divided in two types. In a first plant type glue is injected prior to a dryer, thus on the still wet fibres. This is the so-called wet gluing system. A second plant type uses a dedicated gluing device positioned after the dryer, thus on the at least partially dried fibers. This is a so-called dry gluing system. Glues commonly used in the production of fiberboards are Ureum Formaldehyde (UF), Melamine Formaldehyde (MF), a mixture of the former two (MUF) and polymeric Diphenyl Methylene Diisocyanate (pMDI). The latter is preferred when it is desired to completely avoid release of Formaldehyde in the production environment, as well as in use of a finished product comprising such fiberboard.

A dry gluing system has the advantage of low glue consumption and, in case formaldehyde glues are used, low formaldehyde emission into the atmosphere. However the gluing machine often does not enable the glue to be distributed in a sufficiently uniform manner within the fiber mass, with the result that this plant produces poor quality panels with the formation of lumps and stains which drastically limit the use of the product obtained. In particular the panels produced in this manner cannot be enhanced or lacquered. For the same reason these panels do not present mechanical and technological characteristics which are constant with time and uniform throughout the panel. These drawbacks are more noticeable if poorly reactive glues are used, having a low level of free formaldehyde.

Moreover, as is well known to the expert of the art, the formaldehyde containing glues of class E1 enable panels to be produced containing free formaldehyde, and hence releasable, in a quantity not exceeding 8 mg per 100 g of panel. Due to the production problems associated with such low reactivity glues, it is sometimes necessary to use more reactive glues which however result in higher formaldehyde emission in the pressing stage, with resultant environmental problems. In addition, in the case of low reactivity glues, the fiber mass reaching the press has moisture content of between 2 and 5 wt % which is lower than that necessary for pressing, with the result that this moisture content must be increased to between 8 and 11%.

An improved gluing apparatus is described in US 2007/0001350. It comprises a fiber roller for removing irregularities in the fibers which pass in a flow to the fiber roller. In addition the fibers are stretched. This would ensure that the fibers in the deflection region are finely distributed and provide a large contact surface for the glue which issues out of spray nozzles at the outlet of the fiber roller or in the immediate vicinity of the stream of fibers exiting the roller. Disadvantage of this apparatus is its bulky measurements and cost price of over 2 Mio US dollars. The equipment is difficult to retrofit into existing facilities.

A wet-gluing type of plant, known in the art as a blow-line or glue-line plant, enables better results to be obtained with respect to the quality of the wood panels produced. However, this type of gluing has the drawback of requiring a higher glue consumption about 30-40% more compared to a dry glue system. In addition, in the case of formaldehyde containing glues, it is characterized by a high formaldehyde emission in the production, particularly to the stacks of cyclone separators downstream of the dryer, and a higher free formaldehyde content in the panels produced. In view of health and safety concerns related to formaldehyde, these emissions should be reduced or avoided.

In view of the problems outlined above, it is desirable to improve the gluing process further. It is desirable to provide a gluing process and device that ensures low formaldehyde exhaust. Preferably it has a low cost price. It is desirable that it can easily be retrofitted in existing installations. It would be advantageous that it is easy to maintain. An improved system that has a positive impact on plant efficiency is in demand.

The object of the present invention is to provide an alternative gluing process and/or device which may solve one or more of the problems outlined above.

### SUMMARY

The objects are attainable amongst others by the provision of a device according to claim 1 and/or by a process according to claim 10. The invention further provides a fiber board manufacturing plant according to claim 15. Preferred embodiments are provided in the dependent claims.

### BRIEF DESCRIPTION OF THE DRAWINGS

FIG. 1 illustrates a lay-out of a fiber board manufacturing plant according to the prior art. Glue is introduced into the dryer (wet mixing).

FIG. 2 illustrates an alternative lay-out of a fiber board manufacturing plant according to the prior art. Glue is introduced downstream of the dryer in a separate gluing machine.

FIG. 3 illustrates a lay-out of a fiber board manufacturing plant according to an embodiment of the invention. Glue is introduced into a duct section of an air gravity separator.

FIG. 4 illustrates a duct section of an air density separator provided with means for the injection of dry air and glue according to an embodiment of the invention.

FIG. 5 illustrates a gluing means according to a preferred embodiment of the invention. An air atomizing nozzle with combination clean-out and shut-off needle are depicted.

### DETAILED DESCRIPTION

Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

In a first aspect, the present invention provides an air density separator which is modified to comprise one or more gluing means. In more general terms, the present invention relates to the introduction of a gluing means downstream of the air density separation operation, and in front of the press, more particularly glue is added to the fibers before the to be pressed fiber mat is formed. It is thus clear that, according to a variant of the invention, the gluing means do not necessarily need to be comprised in a duct of the air density separator equipment, but may be comprised in a duct or further equipment between the separation equipment and the mat formation equipment, however in the most preferred embodiment, glue is added in a duct of the air density separator.

The provision of an air density separator that can serve for gluing fibers has the advantage that the gluing process can be moved further downstream closer to the plate press. Gluing can thus be carried out on dried fibers, so called dry-gluing. There is no need for a separate gluing device, although the modified air density separator can be introduced into a fiber board manufacturing line following a prior art gluing device.

With the term “air density separator” a device is meant, which can separate fibers with desired characteristics from contaminants such as dirt, metal particles, wood lumps. In such a device, wood fibers and contaminants are carried in a stream of air. The stream of air is made to move, for instance in an upward flow, such that the fibers remain entrained in the air stream and contaminants of heavier weight move against the current of air under the force of gravity.

In order to obtain an air density separator according to an embodiment of the invention, an existing device can be modified. To this end, a hollow duct section in an air density separator having an inlet opening at a first end, an outlet opening at a second end opposed to said first end and a wall providing said hollow duct, is provided in said wall with one or more gluing means. The separator typically comprises a source of moving air for the direction of a current of air from said inlet opening to said outlet opening. In operation, the source of moving air provides a flow of air for the transportation of a material flow fed to the separator. The material flow comprises wood fibers and materials which are to be separated off from the fibers prior to their use in a plate press. The material to be separated off may comprise undesirables such as dirt, sand or metal fragments. It may also be desired to grade the wood fibers into different product qualities, such as fine and coarse fibers. In an air density separator, the air current is direct such that denser parts, such as metal fragments, follow a different part than lighter parts, such as the wood fibers. Preferably the source of moving air is directed in an upward direction such that denser parts are separated off the lighter parts by means of gravity. In an applied air current, the lighter wood fibers continue their path, while the heavier parts under the force of gravity follow a downward flight. To support this separation process, said duct is preferably an updraft duct. In an updraft duct the air flow moves upward against the force of gravity.

One or more gluing means are provided in the walls of the separator for introduction of a gluing composition. Such gluing means may be provided in the form of glue spray or injection nozzles.

In a preferred embodiment, the insertion of glue into the conduct is air supported. To this end an air atomizing nozzle is preferably used. A glue spray nozzle may comprise an air inlet for introduction of the glue composition into said duct at a pressure of 1-5 bar, preferably 2-4 bar, most preferably around 3.5 bar.

The gluing means are positioned and operable such that a spray or injection of glue into the duct meets with the wood fibers comprised in the air current. The fibers may not only be glued by direct contact but can also be glued by contact with fibers which are already glued.

In a preferred embodiment of an air density separator according to the invention, more than one gluing means are provided for introduction of said glue composition transverse to, e.g. at an angle of 90° to, the transportation direction of the fibers.

In a preferred embodiment an air atomized flow of glue exits into the interior of said duct with an opening angle of between 30° to 60 ° C., preferably 40° to 50° , more preferably 45°. The selection of the spray tip may be advantageous to come as close as possible to contacting the full width of the fiber stream with glue. It is preferable to rely on fiber to fiber contact for the distribution of glue as little as possible.

In a preferred embodiment of an air density separator according to the invention, the glue spray nozzle is provided with a plunger for cleaning out the gluing means of clogged glue composition. The provision of a plunger has the advantage that a continuous gluing operation can be achieved.

In a preferred embodiment of an air density separator according to the invention, the glue spray nozzle is provided with a stopping means for interrupting the introduction of the gluing composition. Said stopping means can shut off an individual nozzle without disturbing the flow from the other nozzles on a same manifold. This provides a more economical arrangement than the use of expensive automatic spray guns.

In a preferred embodiment of an air density separator according to the invention, more than one gluing means are provided on opposing walls of said hollow duct, preferably in positions wherein the gluing are in an offset position from front to back. This arrangement has the advantage that an overlap of spray patterns disrupting one another is avoided.

In a preferred embodiment of an air density separator according to the invention, said separator is further provided with a means for applying a negative pressure to said duct. An operation of the duct under negative pressure has the advantage that glue is contained in the duct, leading to reduced exposure of workers to air born glue. This is particularly interesting when irritating or toxic glues are used.

In a preferred embodiment of an air density separator according to the invention, the glue composition comprises polymeric methylene diphenyl diisocyanate (PMDI). It is noted that the invention enables to convert a wet gluing plant operating with formaldehyde containing glues, in a swift manner to a plant that can operate with pMDI glue. Attempts to inject pMDI glue via the available wet gluing equipment have shown to be insufficient, e.g. problems with clogging are created in the dryer and boards having spots are produced. The inventor has shown that mounting of glue injectors after the separating equipment, preferably on a duct of an air density separator, does away with all of this.

In a second aspect of the invention, a process is provided for obtaining glued dried fibers suitable for the production of fiberboards, characterized by the following steps: carrying dried fibers in an air stream, preferably an upward directed air stream, for the removal of high density contaminants from the dried fibers by means of gravity, and gluing said dried fibers. The improvements obtainable from this shift of the gluing step further downstream in a fiberboard production are the use of the turbulence in an air density separator for contacting glue with fibers. Less glue may be consumed as heavier parts are removed prior to gluing, making the gluing more efficient. With “dried fibers” fibers are meant that have already gone through a drying operation, irrespective of the therein obtained humidity content of the fibers.

In a preferred embodiment of a process according to the invention, the composition for gluing is air atomized.

In a preferred embodiment of a process according to the invention, the dried fiber carrying air stream is spread out to a cross sectional area that is about 3,505 mm wide and about 648 mm deep. In general, the target for resin application is wide but shallow in depth as this provides the best possible result in gluing the fibers. A rectangular shaped cross sectional area is preferred over a circular duct as a rectangle provides a shallower depth to be penetrated than a circular duct would. This provides for maximum application efficiency.

In a preferred embodiment of a process according to the invention, compressed air is introduced to each spraying means for the atomization of the liquid at an air pressure of between 1 to 5 bar, preferably 2 to 4 bar, most preferably around x around 3.5 bar.

In a preferred embodiment of a process according to the invention, gluing is carried out using a 100% solids glue composition, preferably polymeric methylene diphenyl diisocyanate (PMDI). This has the advantage that no moisture is reintroduced with the introduction of the glue composition. To this end, use is preferably made of dried air.

In a final aspect, a fiber board manufacturing plant comprising an air density separator according to an embodiment of the invention is provided and/or a fiber board manufacturing plant comprising an air density separator and a press, wherein glue injecting equipment is positioned downstream of the air density separating operation, but before the formation of the fiber mat to be pressed, wherein the glue is preferably injected in a duct. A fiber board manufacturing plant according to an embodiment of the invention has the advantage that the glue consumption can be reduced. A plant with a modified separator with gluing capabilities according to the invention is more ecofriendly, compact, easier to retrofit, requires less capital investment.

While the foregoing is directed to embodiments of the present invention, other and further embodiments of the invention may be devised without departing from the basic scope thereof and the scope thereof is determined by the claims that follow.

The invention is further described by means of a number of non-limiting examples.

### EXAMPLES

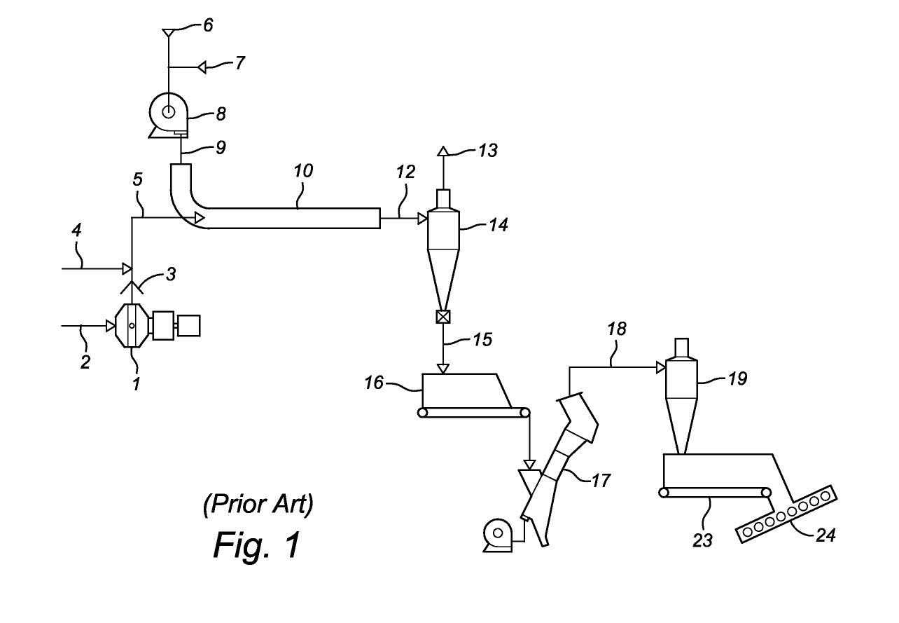

A prior art fiber board manufacturing plant provided with a gluing system of the wet gluing type is provided in FIG. 1. The start position of the manufacturing line is provided with a wood grinder 1, i.e. a machine which, fed with wood and steam (steam indicated by reference number 2), reduces the wood into fiber form. The fibers produced in this manner and mixed with steam (relative humidity 100%) leave the grinder 1 through a blow-up valve 3 and are conveyed by a line 5 to a dryer 10. A liquid glue is injected through the blow-up valve 3 as indicated by the arrow 4 at a pressure of about 6-8 bar, so that a mixture of wood fibers and glue is fed to the dryer 10. Hot gas 6 and air 7 at ambient temperature are also fed to the dryer 10 via a fan 8 and a line 9, to dry the fibers. For this purpose the temperature within the dryer can be varied from 120 to 250° C.

The fibers dried in this manner are conveyed by a line 12 to a bank of cyclones 14, in which the dry fiber is separated from the steam and gas (containing formaldehyde, especially in the case of formaldehyde containing glues) which develop during drying, the steam and gas being discharged to the atmosphere, as indicated by arrow 13.

The fibers leaving the cyclone 14, which have moisture content of between 2 and 10%, are fed via a mechanical conveyor 15 to a continuously operating so-called bunker weigher 16 where they are weighed out. The fibers leaving the bunker weigher 16 are conveyed to an air density separator 17 the purpose of which is to remove the “impurities” present in the fiber, such as glue lumps and coarse fibers. At the exit from the separator 17 the fibers are fed by pneumatic conveying 18 to a cyclone 19 feeding a forming machine 24 via a metering belt 23.

Glue consumption in this type of plant is high, i.e. between 120 and 180 kg per m3 of finished panel, because of the fact that the glue is injected at the blow-up valve 3. In this respect, the glue passes, together with the fibers, through the dryer 10 which operates at high temperature, to hence undergo pre-polymerization which reduces its effectiveness.

Even more penalizing for this method is the presence of formaldehyde originating from the glue in the gas discharged to the atmosphere at 13 after leaving the drying cyclones 13. This means that scrubbers or other removal means have to be used for this gas together with treatment devices for the resultant water, with consequent considerable plant and operating costs. Other removal means may vary as environmental regulations can vary by country. Should a scrubber not suffice, other removal means such as a regenerative thermal oxidizer (RTO), catalytic scrubber, or biofilter could be used to treat this air.

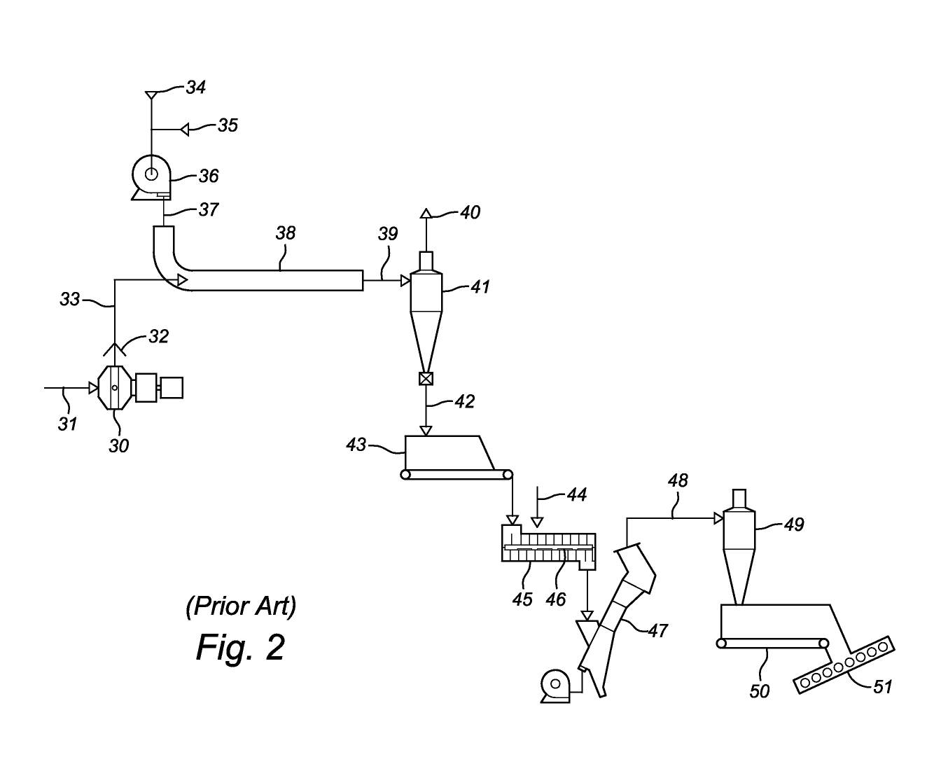

A fiber board manufacturing plant provided with a gluing system of the dry gluing type, according to the prior art, is provided in FIG. 2. It shows a resin-blending plant in which elements similar or identical to those of FIG. 1 can be found.

The plant comprises a grinder 30. The grinder 30 is fed with wood and steam as indicated by arrow 31. The fibers obtained from the grinder 30, and mixed with steam of relative humidity 100%, are conveyed through a blow-up valve 32 and along a line 33 to a dryer 38. Hot gas 34 and air 35 at ambient temperature are also fed to the dryer 38 via a fan 36 and a line 37 to dry the fibers. The dried fibers are then conveyed via a line 39 to a series of cyclones 41 in which the dry fiber is separated from the steam which develops during drying, this being discharged to atmosphere, as indicated by the arrow 40.

The fibers leaving the cyclones 41 and having a moisture content varying from 2 to 10% are fed via a mechanical conveyor 42 to a bunker weigher 43 where they are weighed out, to then be conveyed to a gluing machine, also known as a resin-blending machine 45. This gluing machine is essentially a horizontally positioned cylindrical chamber inside which there is a mixing member 46 consisting basically of a coaxial rotating shaft provided with radial paddles. Liquid glue is injected through nozzles into the chamber, as presented by arrow 44. The mixing members 46 should uniformly distribute the glue throughout the fiber mass. After passing through the entire gluing machine, the fibers are conveyed into an air density separator 47 to separate “impurities” present in the fiber. The fiber is then fed by pneumatic conveying 48 to a cyclone 49 feeding a forming machine 51 via a metering belt 50.

Compared with the preceding plant depicted in FIG. 1 this type of plant has a lower glue consumption and formaldehyde emission to the atmosphere. However the gluing machine 45 does not distribute the glue with sufficient uniformity throughout the fiber mass which may result in poor quality panels with formation of lumps and stains. Because of poor glue distribution, panels may not present mechanical and engineering characteristics that remain constant with time and are uniform throughout the panel.

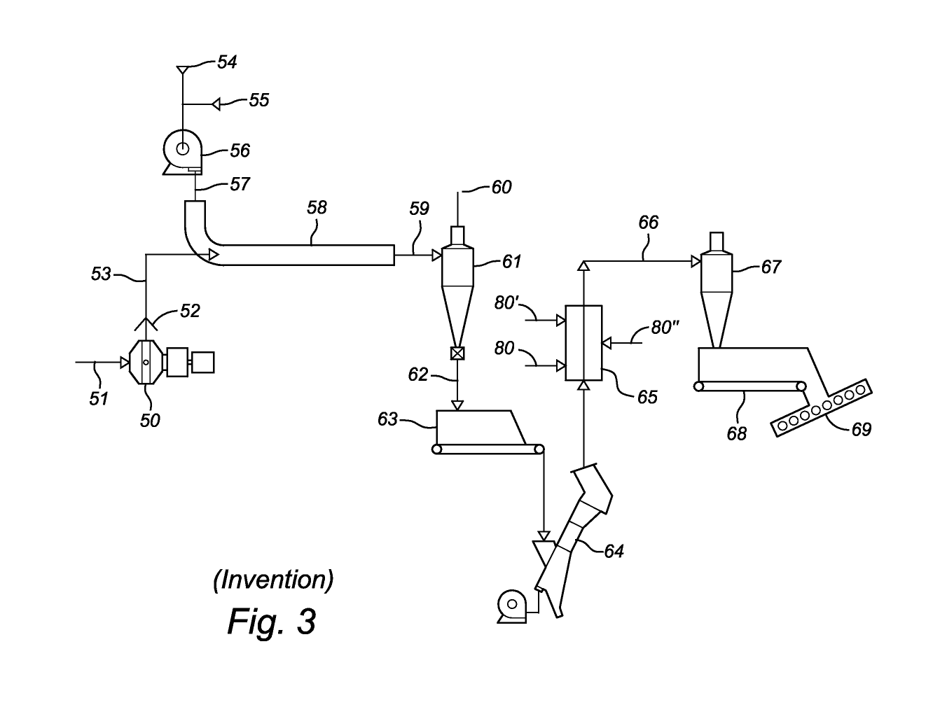

A preferred embodiment of a fiber board manufacturing plant according to the invention is depicted in FIG. 3. The plant comprises a wood grinder 50 for obtaining wood fibers. The grinder 50 is fed with wood and steam as indicated by arrow 51. The wood fibers leaving the grinder 50 through a blow-up valve 52 are fed via a line 53 to a dryer 58. Hot gas 54 and air 55 at ambient temperature are also fed to the dryer 58 via a fan 56 and a line 57 to dry the fibers. The dried fibers are then conveyed via a line 59 to a series of cyclones 61 in which the dry fiber is separated from the steam which develops during drying, this being discharged to atmosphere, as indicated by the arrow 60. The fibers leaving the cyclones 61 and having a moisture content varying from 2 to 10%, preferably 9.5% to 11%, are fed via a mechanical conveyor 62 to a bunker weigher 63 where they are weighed out. The fibers are conveyed to an air density separator 64 the purpose of which is to remove the “impurities” present in the fiber, such as glue lumps and coarse fibers.

Glue is introduced in a duct section 65 of the air gravity separator 65, or downstream of the air gravity separation operation, which is modified to comprise one or more gluing means 80, 80′, 80″ that are in the form of glue spray or injection nozzles. The number of gluing means should be chosen such that a uniform spread of the glue on the moving fibers is reached. It can e.g. be two, three, four, five, ten, fifteen, and twenty.

The gluing means are preferably directed transverse to, e.g. at an angle of 90° to, the transportation direction of the fibers. The glue composition which may be polymeric methylene diphenyl diisocyanate (PMDI) is preferably air atomized into the air stream carrying the dried fibers. The dried fibers carrying air stream are spread out to a cross sectional area that is shallow, e.g. 3,505 mm wide and 648 mm deep. At the exit from the duct section 65 the fibers are fed by pneumatic conveying 66 to a cyclone 67 feeding a forming machine 69 via a metering belt 68.

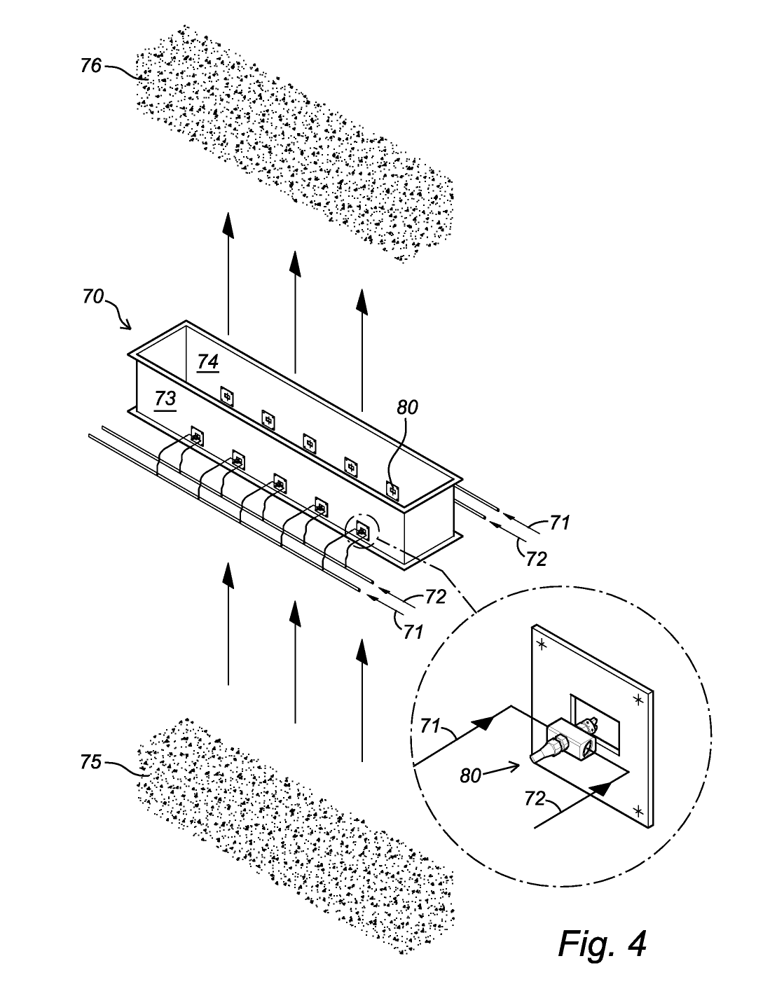

A preferred embodiment of an air density separator duct section 70 provided with gluing means 80 is illustrated in FIG. 4. It depicts a hollow duct 70 of rectangular shape having an inlet opening at a first end, an outlet opening at a second end opposed to said first end and a wall providing said hollow duct, a current of moving air carrying wood fibers 75 enters from the bottom through the inlet opening and travels towards the opposed outlet opening. On its path the wood fibers are glued and the moving air current now carries glued wood fibers 76 that exit the duct via the opposed outlet opening. It can further be seen that the wall that provides the rectangular shaped duct is provided on two opposed sides 73, 74 with gluing means in the form of spray nozzles 80, in this case five in front and five in the back.

The gluing means 80 comprise an injection nozzle connected to an air supply conduit 71 and a conduit for the transportation of a glue composition 72. The five nozzles 80 installed on each side of a wall part of the air density separator 70 permit the application of glue at a 90° angle to the fiber flow and from both sides in the updraft section of the air density separator. The glue composition 72 is supplied from a pump (not shown) into two conduits, one feeds the front five nozzles and the other one feeds the back five nozzles. It is preferably air-atomized.

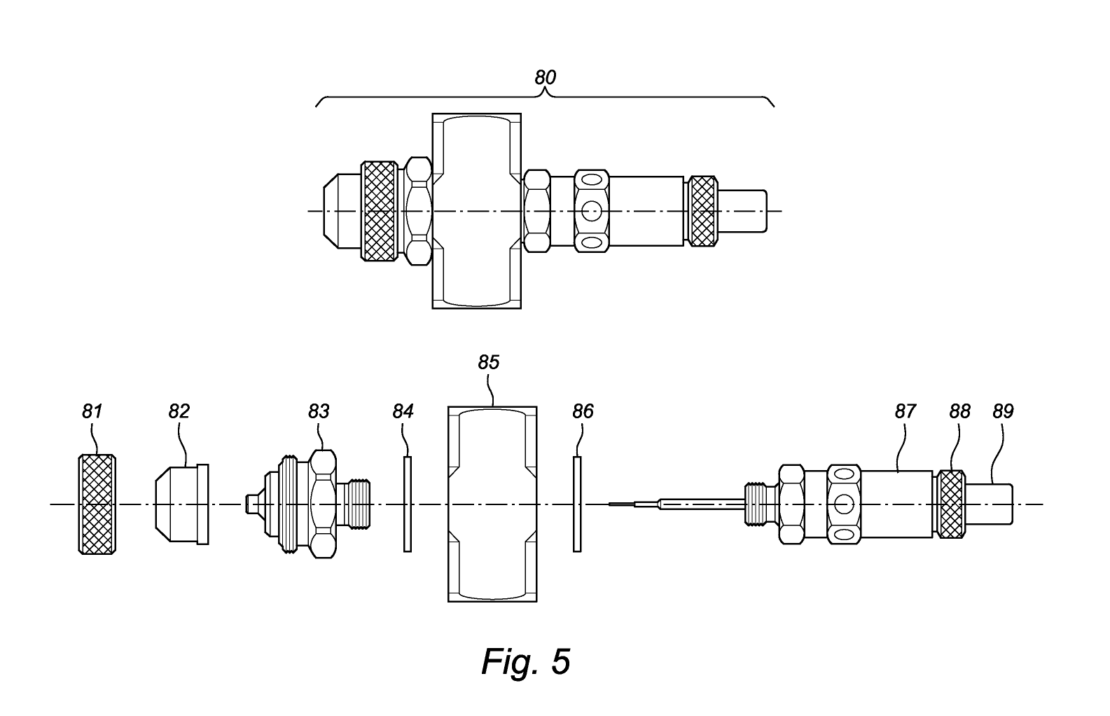

A preferred embodiment of gluing means 80 for use in the present invention is provided in FIG. 5. With reference to the figure, the gluing means 80 comprises an atomizing spraying nozzle set-up 81-86 and shut-off/clean-out needle 87. The spraying nozzle set-up 81-86 is constructed from a nozzle body 85 with two opposing openings, one provided with a fluid cap gasket 84, the opposing one with a back seal gasket 86. A fluid cap 83 is inserted into the fluid cap gasket 84 and nozzle body 85. The fluid cap 83 is provided with an air cap 82 connected to the fluid cap 83 with a retainer ring 81. The nozzle body 85 is provided with an air inlet and a liquid inlet for glue injection (not shown). The gluing means 80 is equipped with a shut-off needle assembly 87 with a stopping means 88 for interrupting the introduction of the glue which can be shut off, on an individual basis. The liquid flow of the nozzle can be stopped by screwing the shut-off screw 88 to screw down into the shut-off setting. In this manner, individual nozzles may be shut-off without disturbing the flow from the other nozzles on the same supply line. This provides an economical arrangement over the use of expensive automatic spray guns. In addition, the needle assembly 87 and hence gluing means 80 is provided with a plunger 89. The fluid cap 83 orifices may be unclogged by pushing a spring loaded plunger 89 into the clean-out position.

In an experiment to glue wood fibers using a gluing means as in FIG. 5, injected glue was air atomized by means of the spray nozzle described with a 45° angled tip using 3.5 bar of atomizing air pressure. Glue dosing could be reduced by up to 15%.

We claim:

1. Air density separator (64) for obtaining glued fibers suitable for fiber board manufacture, comprising
a hollow duct (65) having an inlet opening at a first end, an outlet opening at a second end opposed to said first end and a wall providing said hollow duct,
a source of moving air directed through said duct for the transportation of said fibers from said inlet opening to said outlet opening and separating off contaminants by means of density differences,
one or more gluing means (80, 80′, 80″) provided in said wall for introducing a gluing composition into said hollow duct and onto said fibers.

2. Air density separator (64) according to claim 1, wherein the gluing means (80, 80′, 80″) comprise a glue spray nozzle.

3. Air density separator (64) according to claim 2, wherein the glue spray nozzle comprises an air inlet for introduction of the glue composition into said duct at a pressure of 1-5 bar.

4. Air density separator (64) according to claim 2, wherein the glue spray nozzle is provided with a plunger (89) for cleaning out the gluing means of clogged glue composition.

5. Air density separator (64) according to claim 2, wherein the glue spray nozzle is provided with a stopping means (88) for interrupting the introduction of the gluing composition.

6. Air density separator (64) according to claim 1, wherein more than one gluing means (80, 80′, 80″) are provided on opposing walls of said hollow duct in positions wherein the gluing means are in an offset position from front to back.

7. Air density separator (64) according to claim 1, wherein more than one gluing means (80, 80′, 80″) are provided for introduction of said glue composition at an angle of 90° to the transportation direction of the fibers.

8. Air density separator (64) according to claim 2, wherein a means is provided for applying a negative pressure to said duct.

9. Air density separator (64) according to claim 2, wherein the glue composition comprises polymeric methylene diphenyl diisocyanate (PMDI).

10. A process for obtaining glued dried fibers suitable for the production of fiberboards, characterized by the following steps:
carrying dried fibers in an updraft air stream for the removal of high density contaminants from the dried fibers by means of gravity, and
gluing said dried fibers.

11. Process according to claim 10, wherein the composition for gluing is air atomized.

12. Process according to claim 10, wherein the dried fiber carrying air stream is spread out to a cross sectional area that is about 3,505 mm wide and about 648 mm deep.

13. Process according to claim 10, wherein compressed air is introduced to each spraying means for the atomization of the liquid at an air pressure of 1-5 bar.

14. Process according to claim 10, wherein gluing is carried out using a 100% solids glue composition, preferably polymeric methylene diphenyl diisocyanate (PMDI).

15. Fiber board manufacturing plant comprising an air density separator according to claim 1.
